(19) United States
(12) Patent Application Publication
(10) Pub. No.: US 2009/0099931 A1
(43) Pub. Date: Apr. 16, 2009

(54) System, method and computer program for assocating advertisements with web or wap pages

(75) Inventors: Janne Aaltonen, Turku (FI); Janne Kalliola, Espoo (FI)

Correspondence Address: FRISHAUF, HOLTZ, GOODMAN & CHICK, PC, 220 Fifth Avenue, 16TH Floor, NEW YORK, NY, 10001-7708, US

(73) Assignee: CVON Innovations Ltd., London (GB)

(21) Appl. No.: 12/286,908

(22) Filed: Oct. 2, 2008

Related U.S. Application Data
(60) Provisional application No. 60/997,643, filed on Oct. 4, 2007.

(51) Int. Cl. G06Q 30/00; G06F 15/16; G06F 17/00

(52) U.S. Cl. 705/14; 709/224; 715/234

(57) ABSTRACT

System, method and computer program for associating displayable data, such as advertisements, with Web and WAP pages being delivered from Internet or mobile services to mobile or fixed terminals via a communications network. An intermediate box, which may take the form of, or be resident in, a router, a proxy, a gateway, a server or other network element involved in routing Internet communications, analyzes communications related to Web or WAP browsing being directed to the mobile or fixed terminals and modifies part of the communications to include associated advertisements on Web or WAP pages or to add additional Web or WAP pages for information requests, e.g., interstitial pages.

### CROSS-REFERENCE TO RELATED APPLICATION

This application claims priority under 35 USC 119 of U.S. Provisional Patent Application No. 60/997,643 filed Oct. 4, 2007, the entire disclosure of which is incorporated herein by reference.

### FIELD OF THE INVENTION

The present invention relates generally to systems, methods and computer programs for associating advertisements, and more generally displayable data, with Web or WAP pages being delivered from Internet or mobile services to mobile or fixed terminals via a communications network.

### BACKGROUND INFORMATION

Usage of cellular or mobile telephones and other devices, hereinafter considered as mobile terminals, is very popular and common. The popularity of mobile terminals has enabled their use, along with related infrastructure, as a media for providing mobile marketing, i.e., advertisements to the users of the mobile terminals.

One particular method for providing advertisement to users of mobile terminals is to add a banner type of advertisement in a Web or Wireless Application Protocol (WAP) page accessed by the user. Advertisement revenues of such banner advertisements are typically based on either impressions, i.e., the number of times the advertisement has been potentially seen (in practice downloaded) by users of mobile terminals, or based on a “click through”, i.e., how many times the advertised item has been selected by users of the mobile terminals. Revenue models relating to performance and effectiveness of the click through advertisement technique may be implemented, i.e., data about actual purchasing of advertised products or services relative to the number of times the advertisements have been viewed can be obtained and analyzed to optimize the advertising campaign.

Another issue arising from Web or WAP page advertising is that there may be Web or WAP pages which do not have any advertisements related to the page, for example, due to low amount of traffic on the web site or an inability to enter into a contract with advertisers or advertisement providers. Accessing these pages via a mobile terminal (as well as a fixed terminal) generates fees for the user, telecommunications carrier and/or connectivity provider, yet these parties having only limited means, if any, for generating related revenues to cover the fees.

Yet another concern with Web and WAP pages including advertisements is that providers which are inserting advertisements in the Web and WAP pages that are providing to users' mobile terminals typically do not share revenue derived from the advertisements with the telecommunications carrier or connectivity provider. In view of this inability to obtain such revenue, it is highly unlikely that the telecommunications carriers and connectivity providers would be able to economically provide free or subsidized access to the Internet to users of mobile terminals (as well as fixed terminals).

Nevertheless, some providers provide free access to a limited number of Web or WAP pages to users of mobile and fixed terminals. Typically, these pages contain items for sale or advertisements. To facilitate the free access to these Web or WAP pages, computer software is provided so that IP addresses associated with these Web or WAP pages or URL's of these Web or WAP pages do not generate data traffic costs for the users or alternatively, any costs related to browsing on IP addresses associated with these Web or WAP pages is reimbursed to the users. The providers usually enter into an arrangement with advertisers to receive a share of the revenue arising from sales of advertised items or advertisement revenues related to the Web or WAP page.

### SUMMARY OF THE INVENTION

The present invention is directed at least in part to a system, method and computer program for associating displayable data such as advertisements with Web and WAP pages being delivered from Internet and/or mobile services to mobile or fixed terminals via a communications network. Generally, the system and method provide an intermediate box (IB) which may take the form of a router, a proxy, a gateway and/or a server, and which analyzes at least some of the communications or traffic related to Web or WAP browsing being directed to the mobile or fixed terminals and modifies part of the traffic to include associated advertisements on Web or WAP pages or to add additional Web or WAP pages for information requests, e.g., interstitial pages.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic of a first embodiment of an architecture in which an advertising management system in accordance with the invention can be used.

FIG. 2 is a schematic of a second embodiment of an architecture in which an advertising management system in accordance with the invention can be used.

FIG. 3 shows a first manner in which a Web or WAP page may be modified in accordance with the invention.

FIG. 4 shows a second manner in which a Web or WAP page may be modified in accordance with the invention.

FIG. 5 shows a third manner in which a Web or WAP page may be modified in accordance with the invention.

FIG. 6 shows the results of a browser executing the modification of the Web or WAP page of FIG. 5.

FIG. 7 shows a fourth manner in which a Web or WAP page may be modified in accordance with the invention.

### DETAILED DESCRIPTION

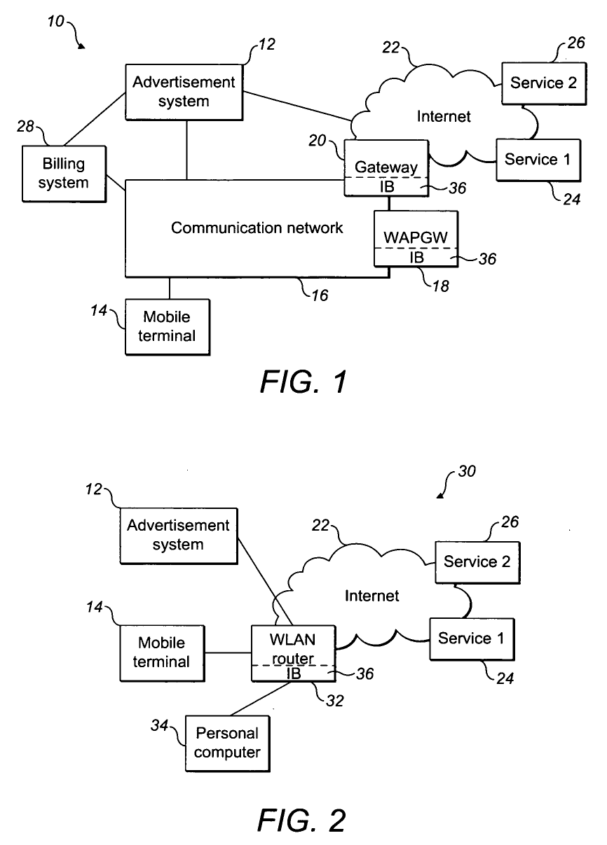

Referring to the accompanying drawings wherein the same reference numerals refer to the same or similar elements, FIG. 1 shows a first embodiment of an architecture in which an advertising management system in accordance with the invention can be used. The advertising management system is designated generally as 10 and may be implemented to provide subsidized or even free mobile telecommunications services, the subsidy being provided by advertisers whose advertisements are being directed to subscribers of the mobile telecommunications service.

The system 10 includes one or more advertisers, defined to include any and all entities or individuals that want to advertise products or services to customers participating in the mobile marketing arrangement, and an advertisement management system 12 that is operated by, for example, an advertising delivery company.

Advertisers can thus refer to a brand owner, a service provider, an advertisement agent, a merchant or any other party that wants to provide advertisements to consumers. Advertisements can be commercial, such as a product or service promotion, or non-commercial, such as a general information service notification. An advertiser can also be a store having a physical presence, an on-line store and the like, which sell or deliver goods and provide services directly to users ordering via the Internet or their mobile terminals 14 (only one of which is shown in FIG. 1).

Typically, the operator of the advertisement management system 12 is a company in the business of delivering advertisements from several advertisers, i.e., it is the intermediary between advertisers and the operators of the advertisement distribution channels. Operation of the advertisement management system 12 is typically managed over an Internet interface.

The advertisement management system 12 preferably includes tools for each advertiser to define rules of their advertisement campaign, i.e., to enable them to tailor the advertisement campaign to their specific desires. This may include reserving, programming and/or booking an advertising campaign via an Internet interface. Parameters which are determined include, but are not limited to, the time period or periods when to send advertisements, the duration of the advertising campaign, the target group or groups, demographics of the target group(s), the format or type of advertisement, the target price level or cost per advertisement or for the advertising campaign in its entirety, the target feedback level of the advertisement, the sociological background of the target audience, interests as declared by the target group(s), demographics of the target group(s) including, for example, age, sex and income level(s), keywords related to the advertisement, a type of Web or WAP site to associate with the advertisement, target telephone type, location of the consumer, etc. An advertiser may also be able to define a set of keywords related to the addressing advertisements to communication sessions between users and/or between users and content services.

In one embodiment, there is an auction of allocatable advertisements and messages to be sent to the users of the mobile terminals 14. As such, advertisers can participate in an auction and bid for the predetermined advertising blocks.

In addition to determining the rules, each advertiser typically provides one or more actual advertisements to the advertising management system 12 in the form of data, text, pictures, video, audio, Flash animations, Portable Document Format (PDF) documents, links, television content, videos, Hypertext Markup Language (HTML), Extensible markup language (xml), Extensible Hypertext Markup Language (xHTML), Wireless Application Protocol (WAP) pages, web pages, etc., or any digital content compatible for reception and display by the users' mobile terminal 14.

The preferences, settings, advertisements, messages, texts, figures, keywords and other rules set by the advertisers relating to the delivery and tagging of communications involving the advertisements may be stored in a database resident in or otherwise associated with the advertisement system 12.

Mobile terminal 14 is arranged to use a communications network 16 to communicate with other elements of the system 10 described below. Communications network 16 can utilize any cellular network technologies that include, but are not limited to, Global System for Mobile Communications (GSM), Wideband Code Division Multiple Access (WCDMA), Code Division Multiple Access (CDMA) and General Packet Radio Service (GPRS). In addition to traditional cellular networks, local area networks such as Wireless Local area networks (WLAN), BlueTooth (BT) and other technologies such as Worldwide Interoperability for Microwave Access (WiMax), Broadcasting over Digital Video Broadcasting-Handheld (DVB-H), Integrated Services Digital Broadcasting-Terrestrial (ISDB-T), (Digital Multimedia Broadcasting) DMB or broadcasting over cellular can be used, e.g., to deliver advertisements as discussed below. The communications network 16 can also be a generic Internet access network using any data transport methods. Moreover, the communications network 16 may be any cellular, broadcast, wide area, local area or Internet network. Communications network 16 can also be a combination of different communications networks such as a Wireless Local Area Network (WLAN) and a Wideband Code Division Multiplex (WCDMA) network. Using the foregoing network(s), the advertisements from advertisers can be Short Message Service (SMS) messages, Multimedia Message Service (MMS) messages, WAP Push, Web pages, or any digital object.

Subscribers to the mobile telephone operator using the mobile terminals 14 can use the same communications network or another communications network as the communications network 16 being used to deliver advertisements from advertisers via the advertisement management system 12, i.e., a hybrid network is possible.

The mobile terminals 14 may be any form of mobile terminal such as a mobile telephone, a smart telephone, a multimedia computer, a personal digital assistant (PDA), a laptop computer or a personal computer. Further, the mobile terminals 14 may be connected to the communications network 16 by means of a wireless and/or wired communication link. For a GSM network, the link between the mobile terminals 14 and the communications network 16 is wireless. At a minimum, the mobile terminals 14 have the capability to communicate with one or more different type of communications networks and have messaging capabilities in the form of a messaging client system such as a short message service (SMS) client system, an e-mail client system, or a multimedia message service client system embedded in the mobile terminal 14. Additionally, mobile terminals 14 may also include a browser to access Web and/or WAP services.

An advertisement can be delivered to the users' mobile terminals 14 via the communications network 16. The communications network 16 may be any cellular, broadcast, wide area, local area or Internet network. For example, FIG. 1 shows a typical layout of a cellular communications network 16 which includes network elements including a WAP Gateway (WAPGW) 18 and an Internet gateway 20. The communications network 16 is connected to the Internet 22 via gateway 20 and enables access to target Internet sites or services 24, 26 for the users of the mobile terminals 14. The WAPGW 18 can enable wireless access to the Internet 22 or dedicated WAP services, e.g., mobile services.

To obtain Internet services 24, 26, a user of the mobile terminal 14 must access the WAPGW 18 and/or Internet gateway 20 via the communications network 16 which is turn is connected to the advertisement management system 12, and this allows for the modification of Web or WAP pages being requested by the user of the mobile terminal 14 from the Internet services 24, 26. Specifically, one or more of the advertisements stored in a database in advertisement management system 12 or in a database accessible thereby, can be added or inserted into Web and WAP pages being provided to the mobile terminal 14, as well as into communication sessions using the Internet 22. The manner in which this is performed in accordance with the invention is described below.

In one embodiment, base stations (BS) and other elements, interfaces and functional components necessary to operate, manage and control communications network 16 may be provided, such as a Short Message Service Center (SMSC) and a Multimedia Message Service Center (MMSC).

System 10 also includes a billing system 28 coupled to the advertisement management system 14 and/or the communications network 16 or specific parts thereof, and may be arranged to monitor and/or meter usage and payments of or for the advertisements being delivered to each mobile terminal 14 by the advertisement management system 14. The billing system 28 may be a real-time billing system or a close-to-real-time billing system.

Referring now to FIG. 2, a second embodiment of an architecture in which the mobile terminal advertising management system in accordance with the invention can be used is designated generally as 30 and includes a Wireless Local Area Network connectivity element or router 32 which is connected to the advertisement management system 12 as described above and to a mobile terminal 14 as described above and/or a personal computer 34. Although a single mobile terminal 14 and personal computer 34 are shown, the invention encompasses use of multiple mobile terminals 14 and/or personal computers 34 and combinations thereof.

The WLAN router 32 enables the users of mobile terminal 14 and personal computer 34 to access Internet services 24, 26 via the Internet 22. The presence of the WLAN router 32 interposed between the Internet 22 and the mobile terminal 14 and personal computer 34 and connected to the advertisement management system 12 allows for the modification of Web or WAP pages being requested by the user of the mobile terminal 14 and personal computer 34 from the Internet services 24, 26. Specifically, one or more of the advertisements stored in a database in advertisement management system 12 or in a database accessible thereby, can be added or inserted into Web and WAP pages being provided to the mobile terminal 14 and personal computer 32, as well as into communication sessions using the Internet 22.

The manner in which an advertisement can be inserted into a Web or WAP page using advertisement management system 12 in accordance with the invention, and which can be applied to the system architectures shown in FIGS. 1 and 2, will now be described.

To enable modification of the Web or WAP pages being provided to the mobile terminal 14 or personal computer 34, an intermediate box (IB) 36 is provided in the WAPGW 18, the Internet gateway 20 and/or the WLAN router 32, or possibly any other network element (for example, another mobile terminal, personal computer, or other network element) via which all or part of the communications or traffic to the user's mobile terminal 14 or personal computer 32 is routed. The functionality of the intermediate box 36 can be implemented in any router or proxy server in the Internet 22 or a portal server in Internet 22. Alternatively, or additional, the functionality of the intermediate box 36 can be implemented in cellular network elements such as GGSN (gateway GPRS (general packet radio service) support node), SGSN (Gateway GPRS (general packet radio service) support node) and a base station.

In whatever form, the intermediate box 36 includes necessary hardware and software to enable it to analyze all or part of the communications or traffic between mobile terminal 14 and personal computer 34 and Internet services 24, 26 and modify, for example, delivered HTML code. For example, the intermediate box 36 may be arranged to parse HTTP traffic, extract XHTML pages from the traffic, and modify the extracted XHTML pages. By modifying the XHTML pages, the intermediate box 36 is able to add banners and other forms of advertisements to the pages being delivered to the mobile terminal 14 and personal computer 34 for viewing by the user(s) thereof. The precise hardware and software necessary to achieve this objective would be readily ascertainable to one of ordinary skill in the art in view of, and as a result of, the disclosure herein.

The following, non-exclusive list sets forth examples of the manner in which the intermediate box 36 can be programmed or otherwise arranged to cause display of one or more advertisements into each Web or WAP page being requested for delivery to mobile terminal 14 and personal computer 34 such that each advertisement would be shown to the user in conjunction with the Web or WAP page. In some embodiments, the advertisement is displayed on the same screen as the requested display page and in others, the advertisement is associated with the requested display page so that the user must view the advertisement in order to view the requested display page with the advertisement being on a different screen than the requested display page.

1. Adding Frames

When a page is requested for viewing by the user through the intermediate box 36, the intermediate box 36 immediately generates a frame-based XHTML page from the requested display page. For example, the XHTML is partitioned into multiple frame parts, e.g., an upper frame and a lower frame whereby the upper frame contains a banner and the lower page contains the original or actual display page sought to be viewed by the user.

The browser of the mobile terminal 14 renders the frame-based page and fetches the content for the upper and lower frames, i.e., the banner and the requested display page.

The intermediate box 36 is notified that the original page is requested inside a frame and does not change anything this time on the requested display page.

However, the browser renders both the upper and lower frames, the upper frame having a banner and the lower frame having the actual, requested display page.

2. Adding a Static Banner XHTML Snippet to the Page

Every static banner snippet has rules governing locations of the page or XHTML code at which the banner snippet may be permissibly inserted.

Accordingly, the intermediate box 36 parses the structure of the requested display page, identifies the permissible insertion location(s) and inserts the XHTML code in the identified insertion location(s) for each advertisement being inserted.

The modified page is delivered to the user's mobile terminal 14 or personal computer 34 and the banner snippet is shown at a permissible location.

3. Adding a Dynamic Banner XHTML Snippet to the Page

Dynamic banner snippets are generated by JavaScript code that writes XHTML code for the banner. Like static banner snippets, every dynamic banner snippet has rules governing locations of the page or XHTML code at which the banner snippet may be permissibly inserted.

The intermediate box parses the structure of the display page requested by the user via the mobile terminal 14 or personal computer 34, identifies the permissible insertion location(s) and inserts the JavaScript code at the identified insertion location(s).

The modified requested display page is delivered to the user's mobile terminal 14 or personal computer 34 and the browser-renders the page and executes the JavaScript code.

When executed by the mobile terminal 14 or personal computer 34, the JavaScript code writes a new set of XHTML instructions which are rendered by the browser to form the dynamic banner snippet which is thus shown to the user in conjunction with the requested display page.

4. Adding Dynamic Banner Injection Scrip to the Page

Dynamic banner injection scrips are generated by JavaScript code that automatically modifies the page DOM model. The intermediate box inserts this JavaScript code into the XHTML code of the display page requested by the user via the mobile terminal 14 or personal computer 34.

The modified requested display page is delivered to the user's mobile terminal 14 or personal computer 34 where the browser renders the modified requested display page and executes the JavaScript code. The code studies the XHTML page structure and injects banners at one or more suitable and permissible locations.

The browser then fetches the banners and displays them to the user in conjunction with the requested display page.

5. Adding an Interstitial

To add an interstitial relating to an advertisement in accordance with the invention, when a display page is requested through the intermediate box 36, the intermediate box 36 automatically generates an interstitial XHTML page that contains the banner. This interstitial page would appear before the requested display page.

Specifically, the browser at the user's mobile terminal 14 or personal computer 34 is directed to render the interstitial page which is displayed to the user when the user has requested another display page.

The user can only receive and view the requested display page only by activating, e.g., by clicking on, a link on the interstitial page. The intermediate box 36 is notified that the requested display page is requested from an interstitial page and does not change anything this time on the requested display page.

The browser is then enabled to render, and proceeds to render, the actual content of the requested display page.

6. Adding Interstitial Code to Links

When a display page from Internet service 24, 26 is requested by the user via mobile terminal 14 or personal computer 34, the intermediate box 36 adds a JavaScript code to the XHTML page for generating interstitial links. For example, if the original markup code includes:

<a href=“/page3.html”>Next</a>|<a href=“/page1.html”>Previous</a> . . .
Then, the modified markup code would include:
<a href=“http://banner.example.com/b/x13/orig;/page3.html”>Next</a>|<a href=“http://banner.example.com/b/x17a/orig;/page1.html”>Previous</a> The browser of the mobile terminal 14 or personal computer 34 renders the modified page and executes the JavaScript code.

When executed, the JavaScript code replaces one or more of the links on the requested display page with links to one or more interstitial pages. The original destination is added as a parameter to the link on each interstitial page.

The user clicks a link on the requested display page and is directed to an interstitial page and the intermediate box 36 delivers the interstitial page. The browser of the mobile terminal 14 or personal computer 34 renders the interstitial page. The user can then activate a link, e.g., by clicking it, on the interstitial page in order to receive the requested display page.

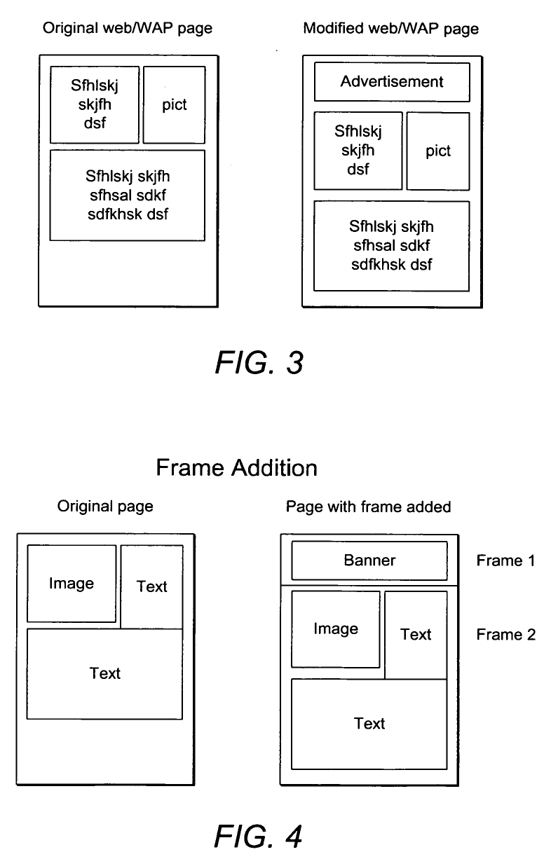

Referring now to FIGS. 3 and 4, examples of the manner in which the intermediate box 36 causes modification of the Web or WAP page being viewed by the user at their mobile terminal 14 or personal computer 34 is shown. The illustration on the left of FIG. 3 shows the original Web or WAP page which as shown, comprises several display elements, such as pictures, text, links, videos and the like, each of which is shown in a separate box. Similarly, the illustration on the left of FIG. 4 shows the original Web or WAP page which as shown, comprises several display elements, such as an image and two text areas, each of which is shown in a separate box. Typically, the main layout of the page is communicated to the browser of the mobile terminal 14 or personal computer 34 using, for example, HTML.

In one embodiment of the invention, the HTML code of the page, as it is downloaded from the Internet service 24, 26 is modified to include additional display elements, such as a picture including an advertisement and possibly also a link to an advertised service, as shown in the illustration on the right in FIG. 3 (the first modification technique described above), or a static banner as shown in the illustration on the right in FIG. 4 (the second modification technique described above). The positioning of the additional, advertisement display element as the uppermost display element on the page shown is not limiting and instead, the display element may be situated in other positions relative to the original display elements of the page, e.g., on the bottom, on the left side, on the right side, in the middle.

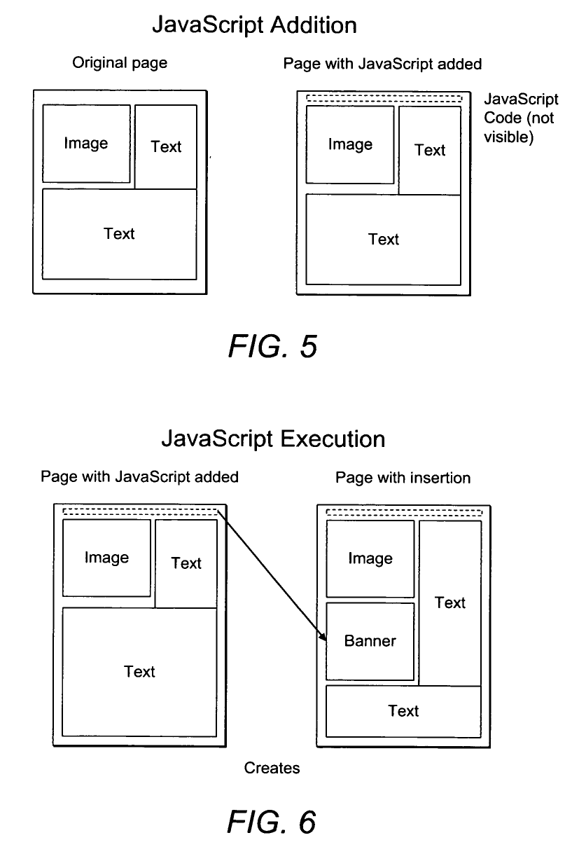

Referring now to FIGS. 5 and 6, another example of the manner in which the intermediate box 36 causes modification of the Web or WAP page being viewed by the user at their mobile terminal 14 or personal computer 34, namely to add an dynamic banner (the third and fourth modification techniques described above), is shown. The illustration on the left of FIG. 5 shows the original Web or WAP page which as shown, comprises several display elements, such as an image and two text areas, each of which is shown in a separate box. The illustration on the right of FIG. 5 (and the left of FIG. 6) shows a modified Web or WAP page including embedded Javascript code. When the modified Web or WAP page is rendered by the browser, the resultant display page includes a banner as shown in the illustration on the right of FIG. 6.

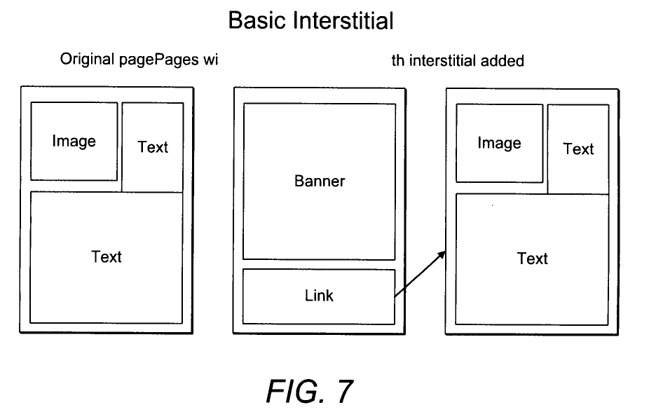

Referring now to FIG. 7, another example of the manner in which the intermediate box 36 causes modification of the Web or WAP page being viewed by the user at their mobile terminal 14 or personal computer 34, namely to add an interstitial page (the fifth modification technique described above), is shown. The illustration on the left of FIG. 7 shows the original Web or WAP page which as shown, comprises several display elements, such as an image and two text areas, each of which is shown in a separate box. The illustration on the right of FIG. 7 shows an interstitial page having a banner and a link to the requested display page.

The advertisement layout in relation to the page can be configured in a variety of different ways and by a variety of different entities involved in the advertising management system and method in accordance with the invention. For example, the advertisement layout may be user-configurable, terminal-configurable, advertiser-configurable and advertisement service provider-configurable.

Selection of the advertisement in the additional display element, which is obtained from the advertisement management system 12, may be made in different ways. For example, the advertisement or advertisements to include in or associate with the page may be selected by the advertisement management system 12 based on a profile of or other information about the user which is stored in a database therein or accessible thereby, based on information content of the target Internet site 24, 26 from which the Web or WAP page is retrieved, based on information about a general category of the accessed Internet site 24, 26, and based on campaigning. Further, the selection of the advertisement(s) may be random, i.e., from among a set of advertisements available to the advertisement management system 12. Also, the selection of the advertisement(s) may be made by the provider of the Internet service 24, 26 from which the Web or WAP page is being retrieved or by the user.

Instead of modifying the Web or WAP pages as described above and shown in FIG. 3, in one embodiment, the original Web or WAP page is maintained, i.e., no additional display elements are included therein when being displayed on the user's mobile terminal 14, but rather, one or more of the links in the original Web or WAP page is removed and each is replaced by a link to an advertisement (the fifth and sixth modification techniques described above). The replacement links direct the user to an advertisement page which shows the advertisements first and then redirects the user to their expected destination, i.e., the destination of the link which has been replaced, whether is it from the same Internet service 24, 26 or a different Internet service 24, 26. Thus, in this case, the requested display page will not appear differently to the user.

The invention enables innovative and focused mobile marketing and advertising. Indeed, the popularity of mobile telephones has enabled their use, along with related infrastructure, as a media for providing mobile marketing, i.e., advertisements to the users of the telephones.

This is important because such a concept is considered by advertisers as the next new channel to directly reach consumers since it utilizes core assets and characteristics of the mobile media, namely, it is personal in that it is directed solely to individual consumers, it is “always on” and can reach the consumers whenever they access their communications devices, it is mobile and naturally forms groups of people who communicate actively with each other. These characteristics combined with social networks-based approaches of the Internet could form a very powerful base to execute marketing strategies.

In general, mobile marketing and advertising can be divided into the following four categories: mobile marketing, mobile advertising, mobile direct marketing and mobile customer relation management (CRM). The present invention in any of its forms discussed above is applicable to all categories.

Mobile marketing is commonly considered as the systematic planning, implementing and control of a mix of business activities intended to bring together buyers and sellers for the mutually advantageous exchange or transfer of products or services where the primary point of contact with the consumer is via their mobile device.

Mobile advertising is commonly considered as the paid, public, non-personal announcement of a persuasive message by an identified sponsor as well as the non-personal presentation or promotion by a firm of its products to its existing customers and potential customers where such communication is delivered to a mobile telephone or other mobile device. Examples of mobile advertising include: Wireless Application Protocol (WAP) Banner ads, mobile search advertising, mobile video bumpers, and interstitial ads in or on device portals.

Mobile direct marketing is commonly considered a sales and promotion technique in which promotional materials are delivered individually to potential customers via the potential customer's mobile telephone or other mobile device. Examples of mobile direct marketing include the sending of Short Message Service (SMS), Multimedia Message Service (MMS) or Wireless Application Protocol (WAP) push messages, Bluetooth messaging and other marketing to mobile telephones or other mobile devices.

Mobile customer relation management is commonly considered as a combination of all the foregoing in a manner that establishes a long-term, engaging relationship between the customer and the marketing or promoting company.

Several computer programs resident on computer-readable media may be used in the invention. One computer program is resident in the advertisement management system 12 and provides advertisements to the communications network 16. Another computer program may be resident in the intermediate box 36 and manages reception of displayable data such as advertisements from the advertisement management system 12 or other source of displayable data, monitors communications and traffic between the Internet services 24, 26 and the mobile terminal 14 and the personal computer 34, receives requested display pages from the Internet services 24, 26, modifies the requested display pages and enables the delivery of the modified requested display pages to the mobile terminal 14 and personal computer 34, i.e., modified to have an associated advertisement or advertisements. Such a computer program can perform all of the functions of the intermediate box 36 as described above, e.g., all of the modification techniques described above.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

In one embodiment of the invention, the Internet service 24, 26 provides streaming media, such as music or video, to the mobile terminal 14 or personal computer 34 and the intermediate box 36 is arranged to interrupt the stream and add one or more advertisements to the stream. The intermediate box 36 thus buffers or pauses the streaming and streams the advertisement instead. After the advertisement has finished, the intermediate box 36 continues to stream the music or video. The intermediate box 36 may be programmed to interrupt the streaming music or video after the passage of a predetermined amount of time. Additionally or alternatively, the intermediate box 36 may be arranged to add one or more advertisements in a video or music download, i.e., into the video or music content.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A system for delivering data to a terminal using a communications network, comprising:
means for providing displayable data; and
means for monitoring a request from the terminal for a display page from an Internet or mobile service via the communications network and modifying the requested display page to associate displayable data received from said means for providing displayable data with the requested display page,
the modified requested display page being deliverable to the terminal via the communications network.

2. The system of claim 1, wherein said means for monitoring the request for a display page and modifying the requested display page are arranged in one of a network element through which at least a part of communications to the terminal are routed, and a cellular network element through which at least a part of communications to the terminal are routed.

3. The system of claim 2, wherein when the means for monitoring the request is said network element, said network is selected from a group consisting of a router, a server, a Wireless Application Protocol gateway (WAPGW) arranged to link the communications network to the Internet or mobile service, an Internet gateway arranged to link the communications network to the Internet or mobile service, and a Wireless Local Area Network (WLAN) router arranged to link the communications network to the Internet or mobile service, wherein said means for monitoring the request is said cellular network, and wherein said cellular network is a GGSN, SGSN or base station.

4. The system of claim 3, wherein said means for monitoring the request for a display page and modifying the requested display page comprise an intermediate box arranged in said WAPGW, said Internet gateway and said WLAN router.

5. The system of claim 1, wherein said displayable data comprises at least one advertisement.

6. The system of claim 1, wherein said means for monitoring the request for a display page and modifying the requested display page are arranged to at least one of:
parse HTTP traffic between the terminal and the Internet or mobile service, extract a requested markup language page from the traffic, modify the extracted markup language page to
include the displayable data, and deliver the modified markup language page to the terminal;
add a display frame relating to the displayable data to the requested display page;
add a static banner markup language snippet relating to the displayable data to the requested display page;
add a dynamic banner markup language snippet relating to the displayable data to the requested display page;
add a dynamic banner injection scrip relating to the displayable data to the requested display page;
add an interstitial relating to the displayable data;
add interstitial code relating to the displayable data to links on the requested display page;
select displayable data to associate with the requested display page based on a profile of or other information about a user of the terminal, based on information content of an Internet site from which the display page is being requested, or based on information about a category of the Internet site from which the display page is being requested; and
associate displayable data with the requested display page in a configuration selected by a user of the terminal, the terminal, an advertiser whose product or service is in at least one advertisement included in the displayable data or when the displayable data comprises at least one advertisement, a service provider of the at least one advertisement.

7. The system of claim 6, wherein when said means for monitoring the request parses, extracts, modifies and delivers, the extracted markup language page is a HTML or XHTML page.

8. The system of claim 6, wherein said means for monitoring the request for the display page and modifying the requested display page add the display frame relating to the displayable data by generating a frame-based markup language page from the requested display page, including the displayable data in a first frame of said frame-based markup language page, and including the original display page in a second frame of said frame-based markup language page whereby when a browser of the terminal renders the frame-based markup language page, it fetches content for said first and second frames and then renders said first and second frames, and
wherein said frame-based markup language page is a HTML or XHTML page.

9. The system of claim 6, wherein when said means for monitoring the request adds a static banner markup language snippet, the static banner markup language snippet is a HTML or XHTML snippet.

10. The system of claim 6, wherein when said means for monitoring the request adds a static banner markup language snippet, said means for monitoring the request for a display page and modifying the requested display page add the static banner snippet to the requested display page by parsing structure of the requested display page, identifying a permissible location for the displayable data and then inserting markup language code in the identified location for the displayable data whereby when the modified page is delivered to the terminal, the banner snippet is shown, and
wherein the markup language code is HTML or XHTML code.

11. The system of claim 6, wherein when said means for monitoring the request adds a dynamic banner markup language snippet, the dynamic banner markup language snippet is a HTML or XHTML snippet.

12. The system of claim 6, wherein when said means for monitoring the request adds a dynamic banner markup language snippet, said means for monitoring request for display pages and modifying the requested display pages add the dynamic banner snippet to the requested display page by parsing structure of the requested display page, identifying a permissible location for the displayable data and then inserting JavaScript code in the identified location for the displayable data whereby when the modified page is delivered to the terminal, the JavaScript code is executed to create markup language instructions which are rendered by a browser to form the dynamic banner snippet, and
wherein the markup language instructions are HTML or XHTML instructions.

13. The system of claim 6, wherein when said means for monitoring the request adds a dynamic banner injection scrip, said means for monitoring the request for a display page and modifying the requested display page add the dynamic banner injection scrip to the requested display page by inserting JavaScript code for generating the dynamic banner injection scrip into markup language code of the requested display page whereby when the modified page is delivered to the terminal, the JavaScript code is executed to cause insertion of the dynamic banner injection scrip at a permissible location, and
wherein the markup language code is HTML or XHTML code.

14. The system of claim 6, wherein when said means for monitoring the request adds an interstitial relating to the displayable data, said means for monitoring the request for a display page and modifying the requested display pages add the interstitial relating to the displayable data by generating an interstitial markup language page relating to the displayable data, requiring the browser of the terminal to render the interstitial page, and requiring activation of a link on the interstitial page in order to obtain the requested display page whereby only if the link is activated, the browser can render the requested display page, and
wherein the interstitial markup language page is an interstitial HTML or XHTML page.

15. The system of claim 6, wherein when said means for monitoring the request adds interstitial code relating to the displayable data to links on the requested display page, said means for monitoring request for display pages and modifying the requested display pages add the interstitial code to the links on the requested display page by adding JavaScript code to the requested display page for generating interstitial links whereby when a browser of the terminal renders the requested display page and executes the JavaScript code, at least one link on the requested display page will direct the browser to an interstitial page, and adding a link to the interstitial page directed to the requested display page whereby when this link is activated, the browser will receive the requested display page.

16. The system of claim 1, wherein said terminal is selected from a group consisting of a mobile telephone, a multimedia computer, a personal digital assistant, a laptop computer and a personal computer.

17. The system of claim 1, wherein the modified requested display page is delivered to the terminal via the communications network such that the requested display page having the associated displayable data is displayed by the terminal.

18. A system for delivering data to a terminal using a communications network, comprising: a data management system including displayable data; and
network elements for routing communications over the communications network between the terminal and an Internet or mobile service, at least one of said network elements including an intermediate box for monitoring a request from the terminal for a display page from the Internet or mobile service via the communications network and modifying the requested display page to associate displayable data received from said management system with the requested display page,
the modified requested display page being deliverable to 10 the terminal via the communications network.

19. The system of claim 18, wherein said displayable data comprises at least one advertisement.

20. The system of claim 18, wherein said at least one network element is selected from a group consisting of a router, a server, a Wireless Application Protocol gateway (WAPGW) arranged to link the communications network to the Internet or mobile service, an Internet gateway arranged to link the communications network to the Internet or mobile service, and a Wireless Local Area Network (WLAN) router arranged to link the communications network to the Internet or mobile service.

21. The system of claim 18, wherein said intermediate box is arranged in a cellular network element, and wherein said cellular network element is a GGSN, SGSN or base station.

22. The system of claim 18, wherein said intermediate box is arranged to at least one of:
parse HTTP traffic between the terminal and the Internet or mobile service, extract a requested markup language page from the traffic, modify the extracted markup language page to include the displayable data, and deliver the modified markup language page to the terminal;
add a display frame relating to the displayable data to the requested display page;
add a static banner markup language snippet relating to the displayable data to the requested display page;
add a dynamic banner markup language snippet relating to the displayable data to the requested display page;
add a dynamic banner injection scrip relating to the displayable data to the requested display page;
add an interstitial relating to the displayable data;
add interstitial code relating to the displayable data to links on the requested display page;
select displayable data to associate with the requested display page based on a profile of or other information about a user of the terminal, based on information content of an Internet site from which the display page is being requested, or based on information about a category of the Internet site from which the display page is being requested; and
associate displayable data with the requested display page in a configuration selected by a user of the terminal, the terminal, an advertiser whose product or service is in at least one advertisement included in the displayable data or when the displayable data comprises at least one advertisement, a service provider of the at least one advertisement.

23. The system of claim 22, wherein when said intermediate box is arranged to parse, extract, modify and deliver, the extracted markup language page is a HTML or XHTML page.

24. The system of claim 22, wherein when said intermediate box is arranged to add a display frame relating to displayable data to the requested display page, said intermediate box is arranged to add the display frame relating to the displayable data by generating a frame-based markup language page from the requested display page, including the displayable data in a first frame of said frame-based markup language page, and including the original display page in a second frame of said frame-based markup language page whereby when a browser of the terminal renders the frame-based markup language page, it fetches content for said first and second frames and then renders said first and second frames, and
wherein said frame-based markup language page is a HTML or XHTML page.

25. The system of claim 22, wherein when said intermediate box is arranged to add a static banner markup language snippet, the static banner markup language snippet is a HTML or XHTML snippet.

26. The system of claim 22, wherein when said intermediate box is arranged to add a static banner markup language snippet, said intermediate box is arranged to add the static banner snippet to the requested display page by parsing structure of the requested display page, identifying a permissible location for the displayable data and then inserting markup language code in the identified location for the displayable data, and
wherein the markup language code is HTML or XHTML code.

27. The system of claim 22, wherein when said intermediate box is arranged to add a dynamic banner, the markup language snippet is a HTML or XHTML snippet.

28. The system of claim 22, wherein when said intermediate box is arranged to add a dynamic banner, said intermediate box is arranged to add the dynamic banner snippet to the requested display page by parsing structure of the requested display page, identifying a permissible location for the displayable data and then inserting JavaScript code in the identified location for the displayable data whereby when the modified page is delivered to the terminal, the JavaScript code is executed to create markup language instructions which are rendered by a browser to form the dynamic banner snippet, and
wherein the markup language instructions are HTML or XHTML instructions.

29. The system of claim 22, wherein when said intermediate box is arranged to add a dynamic banner injection scrip, said intermediate box is arranged to add the dynamic banner injection scrip to the requested display page by inserting JavaScript code for generating the dynamic banner injection scrip into markup language code of the requested display page whereby when the modified page is delivered to the terminal, the JavaScript code is executed to cause insertion of the dynamic banner injection scrip at a permissible location, and
wherein the markup language code is HTML or XHTML code.

30. The system of claim 22, wherein when said intermediate box is arranged to add an interstitial relating to the displayable data, said intermediate box is arranged to add the interstitial relating to the displayable data by generating an interstitial markup language page relating to the displayable data, requiring the browser of the terminal to render the interstitial page, requiring activation of a link on the interstitial page in order to obtain the requested display page and only if the link is activated, enabling the browser to render the requested display page, and
wherein the markup language page is a HTML or XHTML page.

31. The system of claim 22, wherein when said intermediate box is arranged to add interstitial code relating to the displayable data on the requested page, said intermediate box is arranged to add the interstitial code to the links on the requested display page by adding JavaScript code to the requested display page for generating interstitial links whereby when a browser of the terminal renders the requested display page and executes the JavaScript code, at least one link on the requested display page will direct the browser to an interstitial page, and adding a link to the interstitial page directed to the requested display page whereby when this link is activated, the browser will receive the requested display page.

32. The system of claim 18, wherein said terminal is selected from a group consisting of a mobile telephone, a multimedia computer, a personal digital assistant, a laptop computer and a personal computer.

33. The system of claim 18, wherein the modified requested display page is delivered to the terminal via the communications network such that the requested display page having the associated displayable data is displayed by the terminal.

34. A system for delivering data to a terminal using a communications network, comprising:
an intermediate box arranged to communicate with the 10 terminal, an Internet or mobile service and another source of displayable data via the communications network,
said intermediate box being arranged to monitor a request from the terminal for a display page from the Internet or mobile service via the communications network and modify the requested display page to associate displayable data from the source of displayable data with the requested display page,
said intermediate box being further arranged to deliver the modified requested display page to the terminal via the communications network.

35. The system of claim 34, wherein said intermediate box is arranged in a network element through which at least a part of communications to the terminal are routed.

36. The system of claim 35, wherein said network element is selected from a group consisting of a router, a server, a Wireless Application Protocol gateway (WAPGW) arranged to link the communications network to the Internet or mobile service, an Internet gateway arranged to link the communications network to the Internet or mobile service, and a Wireless Local Area Network (WLAN) router arranged to link the communications network to the Internet or mobile service.

37. The system of claim 34, wherein said displayable data comprises at least one advertisement.

38. The system of claim 34, wherein said intermediate box is arranged to at least one of:
parse HTTP traffic between the terminal and the Internet or mobile service, extract a requested markup language page from the traffic, modify the extracted markup language page to include the
displayable data and deliver the modified markup language page to the terminal;
add a display frame relating to the displayable data to the requested display page;
add a static banner markup language snippet relating to the displayable data to the requested display page;
add a dynamic banner markup language snippet relating to the displayable data to the requested display page;
add a dynamic banner injection scrip relating to the displayable data to the requested display page;
add an interstitial relating to the displayable data;
add interstitial code relating to the displayable data to links on the requested display page;
select displayable data to associate with the requested display page based on a profile of or other information about a user of the terminal, based on information content of an Internet site from which the display page is being requested, or based on information about a category of the Internet site from which the display page is being requested; and
associate displayable data with the requested display page in a configuration selected by a user of the terminal, the terminal, an advertiser whose product or service is in at least one advertisement included in the displayable data or when the displayable data comprises at least one advertisement, a service provider of the at least one advertisement.

39. The system of claim 38, wherein when said intermediate box is arranged to add a display frame, said intermediate box adds the display frame relating to the displayable data by generating a frame-based markup language page from the requested display page, including the displayable data in a first frame of said frame-based markup language page, and including the original display page in a second frame of said frame-based markup language page.

40. The system of claim 38, wherein when said intermediate box adds a static banner markup language snippet, said intermediate box adds the static banner snippet to the requested display page by parsing structure of the requested display page, identifying a permissible location for the displayable data and then inserting markup language code in the identified location for the displayable data.

41. The system of claim 38, wherein when said intermediate box adds a dynamic banner markup language snippet, said intermediate box adds the dynamic banner snippet to the requested display page by parsing structure of the requested display page, identifying a permissible location for the displayable data and then inserting JavaScript code in the identified location for the displayable data.

42. The system of claim 38, wherein when said intermediate box is arranged to add a dynamic banner injection scrip, said intermediate box adds the dynamic banner injection scrip to the requested display page by inserting JavaScript code for generating the dynamic banner injection scrip into markup language code of the requested display page.

43. The system of claim 38, wherein when said intermediate box is arranged to add an interstitial relating to the displayable data, said intermediate box adds the interstitial relating to the displayable data by generating an interstitial markup language page relating to the displayable data, requiring the browser of the terminal to render the interstitial page, and requiring activation of a link on the interstitial page in order to obtain the requested display page.

44. The system of claim 38, wherein when said intermediate box is arranged to add interstitial code relating to the displayable data, said intermediate box adds the interstitial code to the links on the requested display page by adding JavaScript code to the requested display page for generating interstitial links whereby when a browser of the terminal renders the requested display page and executes the JavaScript code, at least one link on the requested display page will direct the browser to an interstitial page, and adding a link to the interstitial page directed to the requested display page whereby when this link is activated, the browser will receive the requested display page.

45. A method for delivering data to a terminal using a communications network, comprising:
monitoring a request from the terminal for a display page from an Internet or mobile service via the communications network;
modifying the requested display page to associate displayable data with the requested display page; and
delivering the modified requested display page to the terminal via the communications network.

46. The method of claim 45, wherein the displayable data comprises at least one advertisement.

47. The method of claim 45, wherein the step of monitoring the request from the terminal comprises at least one of:
parsing HTTP traffic between the terminal and the Internet or mobile service and the step of modifying the requested display page comprises extracting a requested markup language page from the traffic and modifying the extracted markup language page to include the displayable data, the modified markup language page being delivered to the terminal;
adding a display frame relating to the displayable data to the requested display page;
adding a static banner markup language snippet relating to the displayable data to the requested display page;
adding a dynamic banner markup language snippet relating to the displayable data to the requested display page;
adding an interstitial relating to the displayable data;
and
adding interstitial code relating to the displayable data to links on the requested display page.

48. The method of claim 47, wherein the step of adding the display frame relating to the displayable data comprises generating a frame-based markup language page from the requested display page, including the displayable data in a first frame of the frame-based markup language page, and including the original display page in a second frame of the frame-based markup language page.

49. The method of claim 47, wherein the step of adding the static banner snippet to the requested display page comprises parsing structure of the requested display page, identifying a permissible location for the displayable data and then inserting markup language code in the identified location for the displayable data.

50. The method of claim 47, wherein the step of adding the dynamic banner snippet to the requested display page comprises parsing structure of the requested display page, identifying a permissible location for the displayable data and then inserting JavaScript code in the identified location for the displayable data whereby when the modified page is delivered to the terminal, the JavaScript code is executed to create markup language instructions which are rendered by a browser to form the dynamic banner snippet.

51. The method of claim 47, wherein the step of adding the dynamic banner injection scrip to the requested display page comprises inserting JavaScript code for generating the dynamic banner injection scrip into markup language code of the requested display page.

52. The method of claim 47, wherein the step of adding the interstitial relating to the displayable data comprises generating an interstitial markup language page relating to the displayable data, requiring the browser of the terminal to render the interstitial page, requiring activation of a link on the interstitial page in order to obtain the requested display page and only if the link is activated, enabling the browser to render the requested display page.

53. The method of claim 47, wherein the step of adding the interstitial code to the links on the requested display page comprises adding JavaScript code to the requested display page for generating interstitial links whereby when a browser of the terminal renders the requested display page and executes the JavaScript code, at least one link on the requested display page will direct the browser to an interstitial page, and adding a link to the interstitial page directed to the requested display page whereby when this link is activated, the browser will receive the requested display page.

54. The method of claim 47, further comprising selecting the displayable data to associate with the requested display page based on a profile of or other information about a user of the terminal, based on information content of an Internet site from which the display page is being requested, or based on information about a category of the Internet site from which the display page is being requested.

55. The method of claim 47, further comprising associating the displayable data with the requested display page in a configuration selected by a user of the terminal, the terminal, an advertiser whose product or service is in at least one advertisement included in the displayable data or when the displayable data comprises at least one advertisement, a service provider of the at least one advertisement.

56. The method of claim 47, further comprising displaying the requested display page having the associated displayable data on the terminal.

57. A computer program resident on computer-readable media and arranged to manage delivery of displayable data to a terminal using a communications network, the computer program being arranged to:
monitor a request from the terminal for a display page from an Internet or mobile service via the communications network; and
modify the requested display page to associate displayable data with the requested display page.

58. The computer program of claim 57, wherein the computer program is further arranged to at least one of:
enable delivery of the modified requested display page to the terminal via the communications network;
monitor the request from the terminal by parsing HTTP traffic between the terminal and the Internet or mobile service and modify the requested display page by extracting a requested markup language page from the traffic and modifying the extracted markup language page to include the displayable data;
modify the requested display page by adding a display frame relating to the displayable data to the requested display page;
modify the requested display page by adding a static banner markup language snippet relating to the displayable data to the requested display page;
modify the requested display page by adding a dynamic banner injection scrip relating to the displayable data to the requested display page;
modify the requested display page by adding an interstitial relating to the displayable data;
modify the requested display page by adding interstitial code relating to the displayable data to links on the requested display page;
select the displayable data to associate with the requested display page based on a profile of or other information about a user of the terminal, based on information content of an Internet site from which the display page is being requested, or based on information about a category of the Internet site from which the display page is being requested; and
associate the displayable data with the requested display page in a configuration selected by a user of the terminal, the terminal, an advertiser whose product or service is in at least one advertisement included in the displayable data or when the displayable data comprises at least one advertisement, a service provider of the at least one advertisement.

59. The computer program of claim 58, wherein when the computer program is arranged to add the display frame relating to the displayable data, this is accomplished by generating a frame-based markup language page from the requested display page, including the displayable data in a first frame of the frame-based markup language page, and including the original display page in a second frame of the frame-based markup language page.

60. The computer program of claim 58, wherein when the computer program is arranged to add the static banner snippet to the requested display page, this is accomplished by parsing structure of the requested display page, identifying a permissible location for the displayable data and then inserting markup language code in the identified location for the displayable data.

61. The computer program of claim 58, wherein when the computer program is arranged to add the dynamic banner snippet to the requested display page, this is accomplished by parsing structure of the requested display page, identifying a permissible location for the displayable data and then inserting JavaScript code in the identified location for the displayable data.

62. The computer program of claim 58, wherein the computer program is arranged to add the dynamic banner injection scrip to the requested display page by inserting JavaScript code for generating the dynamic banner injection scrip into markup language code of the requested display page.

63. The computer program of claim 58, wherein the computer program is arranged to add the interstitial relating to the displayable data by generating an interstitial markup language page relating to the displayable data, requiring the browser of the terminal to render the interstitial page, requiring activation of a link on the interstitial page in order to obtain the requested display page and only if the link is activated, enabling the browser to render the requested display page.

64. The computer program of claim 58, wherein when the computer program is arranged to add the interstitial code to the links on the requested display page, this is accomplished by adding JavaScript code to the requested display page for generating interstitial links whereby when a browser of the terminal renders the requested display page and executes the JavaScript code, at least one link on the requested display page will direct the browser to an interstitial page, and adding a link to the interstitial page directed to the requested display page whereby when this link is activated, the browser will receive the requested display page.
